(19) United States
(12) Patent Application Publication
(10) Pub. No.: US 2006/0165109 A1
(43) Pub. Date: Jul. 27, 2006

(54) Data communication device

(75) Inventors: Yuki Kitamura, Kyoto (JP); Kunihiko Hayashi, Osaka (JP); Motohide Nishibata, Wakayama (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/121,025

(22) Filed: May 4, 2005

(30) Foreign Application Priority Data
Nov. 6, 2004 (JP) 2004-173854

(51) Int. Cl. H04L 12/56; H04L 12/28

(52) U.S. Cl. 370/412

(57) ABSTRACT

A data communication device is provided wherein a data storage region and a process request region indicative of whether or not there is a process request of data transmission are secured on a memory. A data transmission section receives a request for data transmission from a transmission module to store data in the data storage region and, only when a process request is not yet written in the process request region, writes a process request in the process request region to issue an interrupt to a process request receiving section. The process request receiving section confirms that a process request is written in the process request region and clears the process request to notify a reception module about data storage in the data storage region. A data acquisition section receives a request for data reception from the reception module to acquire data from the data storage region.

### CROSS-REFERENCE TO RELATED APPLICATION

This application claims priority under 35 U.S.C. § 119(a) on Japanese Patent Application No. 2004-173854 filed on Jun. 11, 2004, the entire contents of the specification, drawings and claims of which are hereby incorporated by reference.

### BACKGROUND OF THE INVENTION

The present invention relates to a data communication device used for communication between software modules (hereinafter, simply referred to as “module(s)”) of processors.

In a conventional intermodule data communication, data is written in a data region of a shared memory prescribed between a transmission module and a reception module, and an interrupt is issued to the reception module. The reception module is activated by the interrupt to identify the transmission module based on the value of an interrupt request register. After the reception module receives data from the shared memory, the reception module writes a notice of a service result (process completion notice) in a completion information storage region of the shared memory prescribed between the reception module and the transmission module (see, for example, Japanese Unexamined Patent Publication No. 5-216792).

However, in a data communication based on the above conventional technique, an interrupt is issued to the reception module every time the transmission module sends data to the reception module. Thus, in the case where data is sent continuously, an overhead is large because of interrupts. Further, the transmission module cannot send the next data till the current data is acquired by the reception module and a process completion notice is written in the shared memory. If the data acquisition process of the reception module is delayed, a delay is also caused in the process of the transmission module.

### SUMMARY OF THE INVENTION

An objective of the present invention is to provide a data communication device in which the frequency of occurrence of interrupts in data transmission is decreased.

Another objective of the present invention is to provide a data communication device that realizes a data transmission in which the operations of a transmission module and a reception module do not influence each other even when the transmission module and the reception module operate in an asynchronous manner.

In order to solve the above problems, the first data communication device of the present invention comprises: a memory including a data storage region and a process request region, the data storage region having an identifier indicative of a first state or a second state, the process request region indicating whether or not there is a process request for data transmission; a data transmission section which receives from at least one transmission module a request for data transmission to store data in a region in which the identifier of the data storage region indicates the second state and then change the identifier to the first state and, only when a process request is not yet written in the process request region, writes a process request in the process request region to generate a notice signal; a process request receiving section which receives the notice signal to confirm that a process request is written in the process request region and then clears the process request to notify a reception module about data storage in the data storage region; and a data acquisition section which receives from the reception module a request for data reception to acquire data from a region in which the identifier of the data storage region indicates the first state and then change the identifier to the second state. With this structure, the transmission module is capable of continuously transmitting data without being influenced by the timing of the data acquisition process of the reception module. When a process request is in the process request region, the notice signal is not repeatedly generated. Thus, it is possible to reduce the number of times the process of the reception module is interrupted by an interrupt process of a communication process request.

In the first data communication device, the identifier may represent data read permission or data read prohibition. The transmission module stores data in a data storage region in which the identifier indicates data read prohibition. The reception module acquires data from a data storage region in which the identifier indicates data read permission. With this structure, for example, it is possible to exclusively access the data storage region without special exclusion control of a processor bus.

The process request receiving section of the first data communication device preferably includes: a timer which receives from the reception module a registration request for a data acquisition interval to register the data acquisition interval as an interval of a data storage notice to the reception module and notifies the reception module about data storage in the data storage region according to the interval of the data storage notice; a process request determination section which receives the notice signal to confirm that a process request is written in the process request region and then clears the process request to instruct the timer to start operation; and a timer control section which receives from the reception module a stop request for a data storage notice to instruct the timer to stop operation. With this structure, the reception module can acquire data with a predetermined interval.

When process requests from a plurality of transmission modules to a same reception module are written in the process request region, the process request receiving section of the first data communication device may clear all the plurality of process requests and notify the reception module only once about data storage in the data storage region together with transmission module information. With this structure, the number of times the data storage notice is issued to the reception module is reduced, and the number of times the process of the reception module is interrupted by an interrupt process of a communication process request is further reduced.

The second data communication device of the present invention comprises: a memory including a data storage region, a process request region, and a resource information region in which a notice data amount is registered, the data storage region having an identifier indicative of a first state or a second state, the process request region indicating whether or not there is a process request for data transmission; a data transmission section which receives from at least one transmission module a request for data transmission to store data in a region in which the identifier of the data storage region indicates the second state and then change the identifier to the first state and, only when a stored data amount of the data storage region is equal to or larger than the notice data amount registered in the resource information region, writes a process request in the process request region to generate a notice signal; a process request receiving section which receives the notice signal to confirm that a process request is written in the process request region and then clears the process request to notify a reception module about data storage in the data storage region; and a data acquisition section which receives from the reception module a request for data reception to acquire data from a region in which the identifier of the data storage region indicates the first state and then change the identifier to the second state. With this structure, the number of times the process of the reception module is interrupted by an interrupt process of a communication process request is reduced.

The second data communication device may have a structure wherein: the resource information region further includes information which represents the total amount of data already stored in the data storage region; and the data transmission section receives from at least one transmission module a request for data transmission to store data in a region in which the identifier of the data storage region indicates the second state and then change the identifier to the first state and, only when the total amount of data already stored in the data storage region is equal to or larger than the notice data amount registered in the resource information region, initializes the information which represents the total amount of the already-stored data and writes a process request in the process request region to generate a notice signal.

The first effect of the present invention resides in that the number of times a notice is issued from a transmission module to a reception module in data transmission is reduced. As a result, it is possible to reduce the number of times a process of the reception module and processes of other modules are interrupted by an interrupt process of a communication process request.

The second effect of the present invention resides in that, when a transmission module and a reception module operate in an asynchronous manner, the operations of the modules do not influence each other. Since the data storage region includes transmission data and an identifier which indicates read permission or prohibition of data, the transmission module is capable of storing a plurality of pieces of data in data storage regions at arbitrary timings, and the reception module is capable of storing, in response to a request for data reception, data accompanied by an identifier which indicates data read permission at an arbitrary timing, any module is not left waiting even when the operation timing is different between the transmission module and the reception module or when the reception module has a low responsiveness to an interrupt.

### BRIEF DESCRIPTION OF THE DRAWINGS

FIG. 1 is a block diagram showing an example of a structure of a data communication system according to the present invention.

FIG. 2 is a block diagram showing the first embodiment of a data communication device between software modules in the system of FIG. 1.

FIG. 3 is a timing chart showing an operation of the data communication device of FIG. 2.

FIG. 4 is a conceptual diagram illustrating a structure of a data storage region of FIG. 2.

FIG. 5 is a flowchart illustrating a data storage procedure wherein the data storage region of FIG. 4 is employed.

FIG. 6A, FIG. 6B and FIG. 6C are conceptual diagrams illustrating the data storage procedure of FIG. 5.

FIG. 7 is a flowchart illustrating a data acquisition procedure wherein the data storage region of FIG. 4 is employed.

FIG. 8A, FIG. 8B and FIG. 8C are conceptual diagrams illustrating the data acquisition procedure of FIG. 7.

FIG. 9 is a conceptual diagram illustrating another example of the structure of the data storage region of FIG. 2.

FIG. 10 is a flowchart illustrating a data storage procedure wherein the data storage region of FIG. 9 is employed.

FIG. 11A, FIG. 11B and FIG. 11C are conceptual diagrams illustrating the data storage procedure of FIG. 10.

FIG. 12 is a flowchart illustrating a data acquisition procedure wherein the data storage region of FIG. 9 is employed.

FIG. 13A, FIG. 13B and FIG. 13C are conceptual diagrams illustrating the data acquisition procedure of FIG. 12.

FIG. 14 is a block diagram showing the second embodiment of a data communication device between software modules in the system of FIG. 1.

FIG. 15 is a block diagram showing an example of a detailed structure of a process request receiving section of FIG. 14.

FIG. 16 is a block diagram showing the third embodiment of a data communication device between software modules in the system of FIG. 1.

FIG. 17 is a block diagram showing the fourth embodiment of a data communication device between software modules in the system of FIG. 1.

FIG. 18 is a block diagram showing the fifth embodiment of a data communication device between software modules in the system of FIG. 1.

### DESCRIPTION OF THE PREFERRED EMBODIMENTS

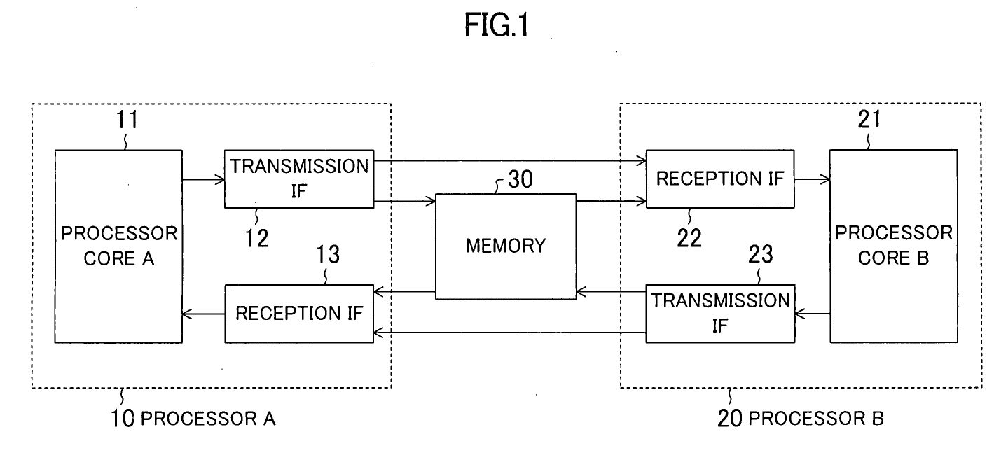

FIG. 1 shows an example of a structure of a data communication system according to the present invention. In the system of FIG. 1, a memory 30 is interposed between two processors 10 and 20 such that bidirectional communication can be established between software modules of the processors 10 and 20. The processor (processor A) 10 includes a processor core 11, a transmission interface (transmission IF) 12, and a reception interface (reception IF) 13. The processor (processor B) 20 also includes a processor core 21, a reception IF 22, and a transmission IF 23. In this system, bidirectional communication can be achieved between a plurality of modules executed by the processor 10 and a plurality of modules executed by the processor 20. It should be noted that three or more processors may be connected through the memory 30.

Hereinafter, five embodiments of a data communication device between the software modules in the system of FIG. 1 will be described.

### Embodiment 1

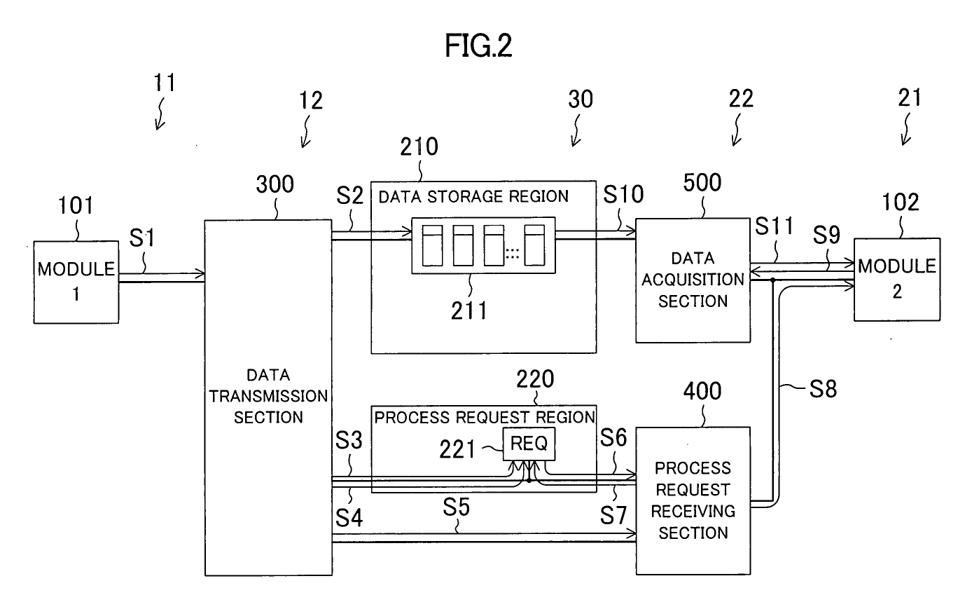

FIG. 2 shows the first embodiment of the data communication device of the present invention. Herein, it is assumed that data is sent from a transmission module (module 1) 101 executed by the processor core 11 to a reception module (module 2) 102 executed by the processor core 21. Each of the transmission module 101 and the reception module 102 includes a plurality of modules. The transmission IF 12 has a data transmission section 300. The reception IF 22 has a process request receiving section 400 and a data acquisition section 500. The memory 30 has a data storage region 210 for storing data which is to be transmitted between the modules and a process request region 220 for notifying that data is stored.

The data transmission section 300 stores data in the data storage region 210 and issues a data communication process request. The process request receiving section 400 receives the data communication process request from the data transmission section 300 and notifies the reception module 102 about the data storage in the data storage region 210. The data acquisition section 500 acquires the data from the data storage region 210 and transfers the acquired data to the reception module 102.

The data storage region 210 secures an exclusive region for each of the combinations of the plurality of modules included in the transmission module 101 and the reception module 102. As for the structure, the data storage region 210 includes a region in which transmission data is to be written and an identifier which indicates whether or not the write region of the transmission data is permitted to be read. In the data communication device shown in FIG. 2, a data storage region 211 is secured for data transmission from the transmission module 101 to the reception module 102.

The process request region 220 represents a data communication process request (REQ) for the data storage region exclusively provided for each combination of the transmission module 101 and the reception module 102 in the data storage region 210. For example, the process request region 220 may be a queue for storing a pointer of the data storage region 210 which includes a data reception request on a request issuance time series basis.

In FIG. 2, arrows show the flow of control. When transmitting data, the module 101 issues a transmission request including transmission destination module information and transmission data to the data transmission section 300 (S1). Receiving from the module 101 the transmission data and the data transmission request to the reception module 102 (S1), the data transmission section 300 stores the transmission data in the data storage region 211 (S2) and checks the process request region 220 (S3). If the process request region 220 does not include a process request 221 which corresponds to the data storage region 211, the data transmission section 300 writes a process request 221 which corresponds to the data storage region 211 in the process request region 220 (S4) and issues an interrupt to the process request receiving section 400 (S5). If the process request region 220 already includes a process request 221 which corresponds to the data storage region 211, the data transmission section 300 does not write a process request 221 in the process request region 220.

The process request receiving section 400 receives the interrupt from the data transmission section 300 (S5) to determine the process request of the process request region 220 (S6). If the process request region 220 includes the process request 221, the process request receiving section 400 clears the process request 221 (S7) and notifies the module 102 about the data reception from the module 101 (S8). If the reception module 102 receives the notice of data reception from the module 101 (S8), the reception module 102 issues to the data acquisition section 500 a reception request of the transmission data from the module 101 to the module 102 and repeats a data acquisition process (S9). When receiving from the data acquisition section 500 a notice that the data storage region 211 includes no data which is permitted to be read, the module 102 terminates the process. When receiving from the module 102 the request for reception of transmission data from the module 101 (S9), the data acquisition section 500 acquires data from the data storage region 211 (S10) and transfers the acquired data to the module 102 (S11). It should be noted that, if the data storage region 211 includes no data which is permitted to be read, the data acquisition section 500 notifies the module 102 that the data storage region 211 includes no data which is permitted to be read (S11).

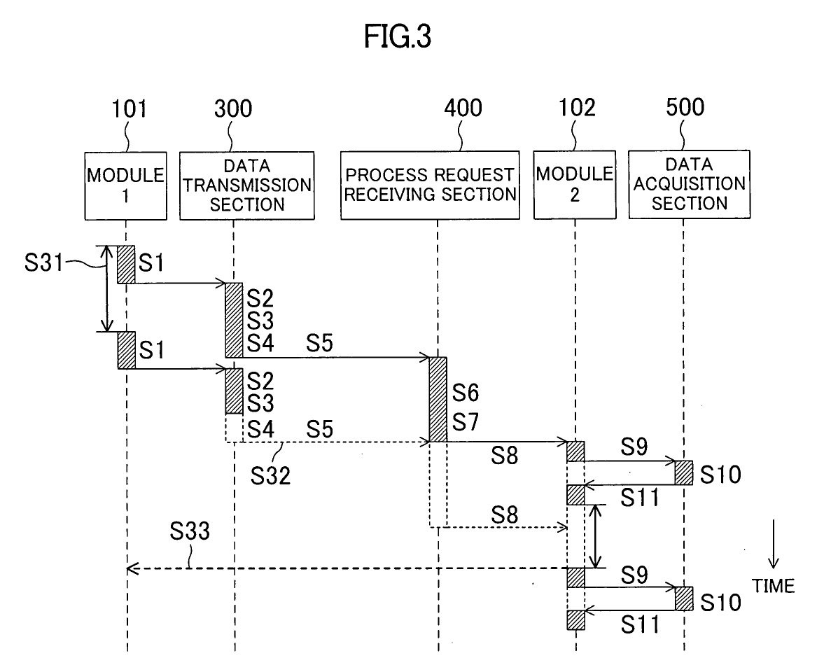

FIG. 3 shows the operation of the data communication device of FIG. 2. In a data communication using the data communication device of FIG. 2, if the process request region 220 includes the process request 221, the data transmission section 300 does not repeatedly issue a communication process request to the process request receiving section 400 (S32). Therefore, the number of times the process of module 2 is interrupted by an interrupt process of the communication process request is reduced, and the process performance achieved when data communication continuously occurs is improved. Further, in the case of data communication with the data communication device of the present invention, module 1 can transmit the next data without waiting for acquisition of the current data by module 2 (S31). Thus, the process of module 1 is not influenced by the timing of the data acquisition process of module 2 (S33).

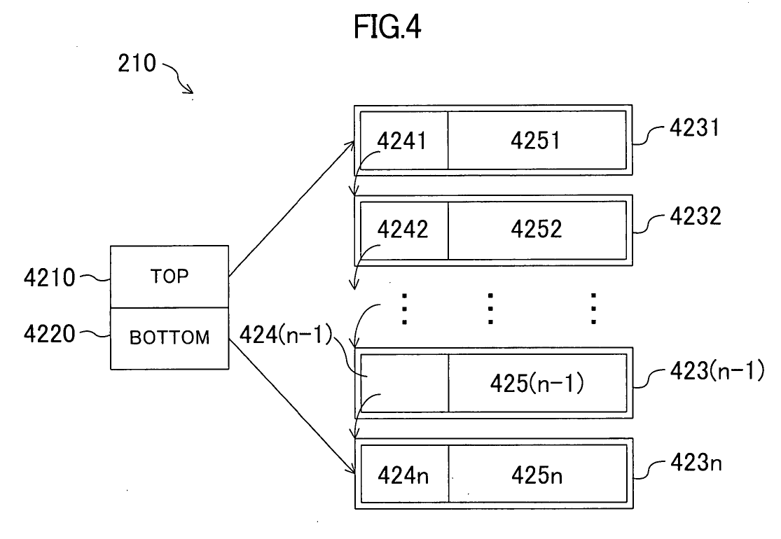

FIG. 4 shows an example of a structure of the data storage region 210 of FIG. 2. The data storage region 210 is formed by a data buffer sequence, a pointer 4210 and a pointer 4220 as shown in FIG. 4. The data buffer sequence includes data buffers 4231 to 423n, each of which includes a data region for storing transmission data and an identifier indicative of read permission/prohibition of the data region. The data buffers 4231 to 423n are linked by pointers set in the identifiers, each of the pointers being directed to the next data buffer from which the data is permitted to be read. The identifier 424n of the data buffer 423n at the end of the data buffer sequence has a specific value indicative of read prohibition (e.g., 0). The pointer 4210 indicates the leading data buffer 4231 of the n data buffers 4231 to 423n (hereinafter, referred to as “top”). The pointer 4220 indicates the data buffer 423n at the end of the data buffer sequence (hereinafter, referred to as “bottom”).

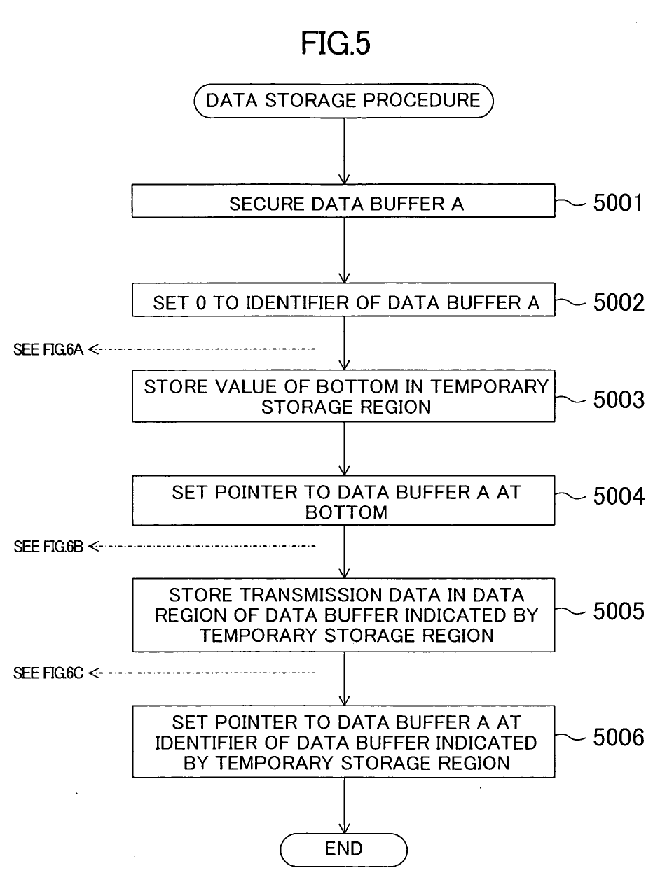

FIG. 5 illustrates a data storage procedure wherein the data storage region 210 of FIG. 4 is employed. According to FIG. 5, data buffer A which stores no data is secured (step 5001), and the identifier is set to 0 (step 5002). The value of the bottom is stored in a temporary storage region (step 5003). The bottom 4220 is changed to a pointer directed to data buffer A (step 5004). Data is stored in a data region of data buffer B which is indicated by the temporary storage region (step 5005). In the last, the pointer directed to data buffer A is set in the identifier of data buffer B, whereby the data region of data buffer B is permitted to be read (step 5006). Step 5003 may be performed at any point in time so long as it is prior to step 5004. Step 5004 may be performed after step 5005.

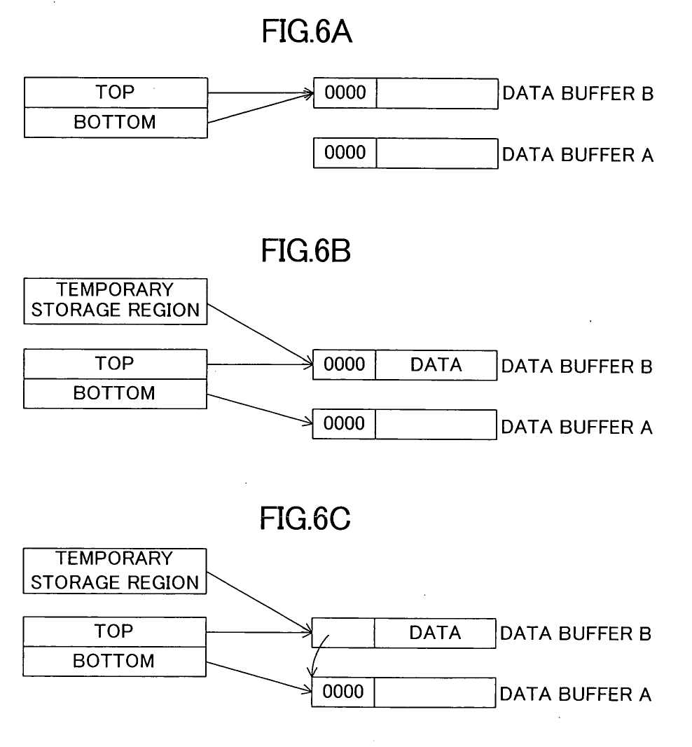

FIG. 6A shows the state of the data storage region 210 at the time when step 5001 and step 5002 are completed. FIG. 6B shows the state of the data storage region 210 at the time when steps 5003 to 5005 are completed. FIG. 6C shows the state of the data storage region 210 at the end of the data storage process.

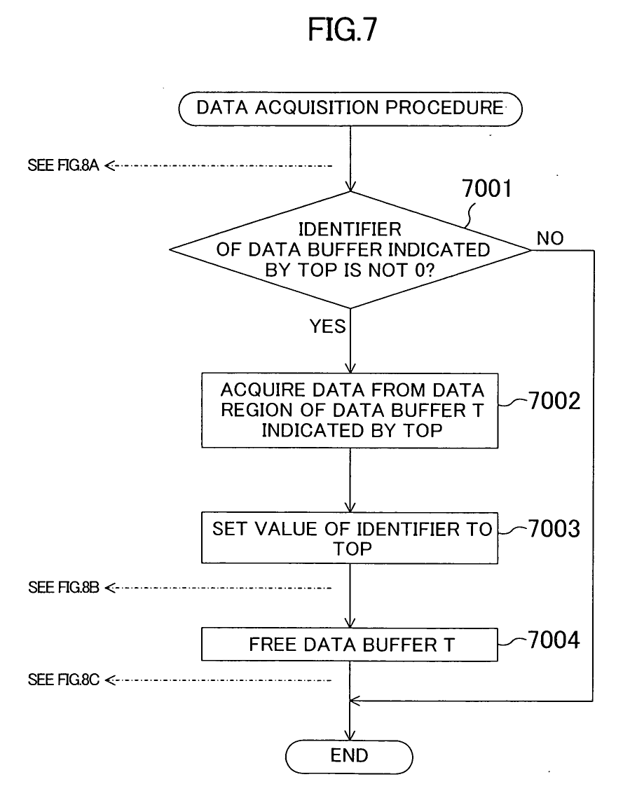

FIG. 7 illustrates a data acquisition procedure wherein the data storage region 210 of FIG. 4 is employed. According to FIG. 7, the identifier of data buffer T indicated by the top 4210 is determined (step 7001). If the identifier indicates read permission, data is acquired from the data region of data buffer T indicated by the top 4210 (step 7002). After the top 4210 is changed to the value of the identifier of data buffer T (step 7003), data buffer T is freed (step 7004).

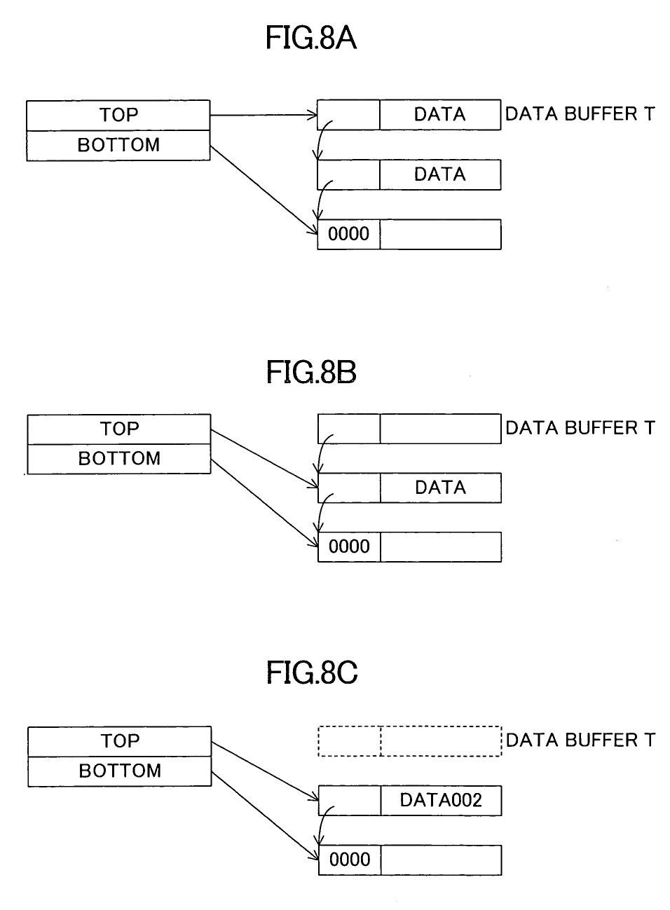

FIG. 8A shows the state of the data storage region 210 before step 7001 is performed with two pieces of data stored in the data storage region 210. FIG. 8B shows the state of the data storage region 210 at the time when steps 7001 to 7003 are completed. FIG. 8C shows the state of the data storage region 210 at the end of step 7004.

It should be noted that the data buffer may have a region in which a leading point of transmission data and the size of the transmission data are to be written in place of the data region.

The identifier may be a flag indicative of read permission or read prohibition. The data buffer may have a region for storing a pointer indicative of the next data buffer separately from the identifier.

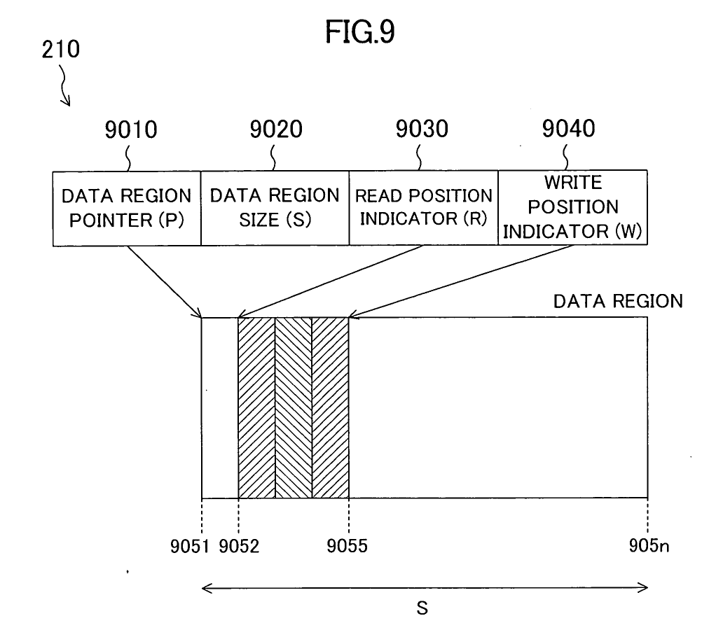

FIG. 9 illustrates another example of the structure of the data storage region 210 of FIG. 2. As shown in FIG. 9, the data storage region 210 includes continuous data regions 9051 to 905n, a data region pointer (P) 9010 which indicates the leading end 9051 of the data regions, a data region size (S) 9020 for storing the entire size S of the data regions 9051 to 905n, a read position indicator (R) 9030 and a write position indicator (W) 9040. It is assumed herein that the region extending from the read position indicator (R) to the write position indicator (W) is a read-permitted region, and the region other than the read-permitted region is a write-permitted region. When data is stored, writing of the data is started from a position indicated by the write position indicator (W). After the writing of the data is completed, the write position indicator (W) is moved to the trailing end of the data. When data is acquired, reading of the data is started from the position indicated by the read position indicator (R). After the data is read up to any position before the write position indicator (W), the read position indicator (R) is updated to indicate the leading end of an unacquired data region.

The writing and reading of data proceed in the same direction. Assuming that the writing or reading of data proceeds from the data region 9051 to the data region 905n, after the data region 905n is reached, the writing or reading is resumed from the data region 9051. For the purpose of determining whether or not the data region includes data when the read position indicator (R) and the write position indicator (W) indicate the same position, a rule may be set such that the state where the read position indicator (R) and the write position indicator (W) indicate the same position is recognized as no read-permitted data being included in the data region, and writing of data is stopped one data unit immediately before the read position indicator (R).

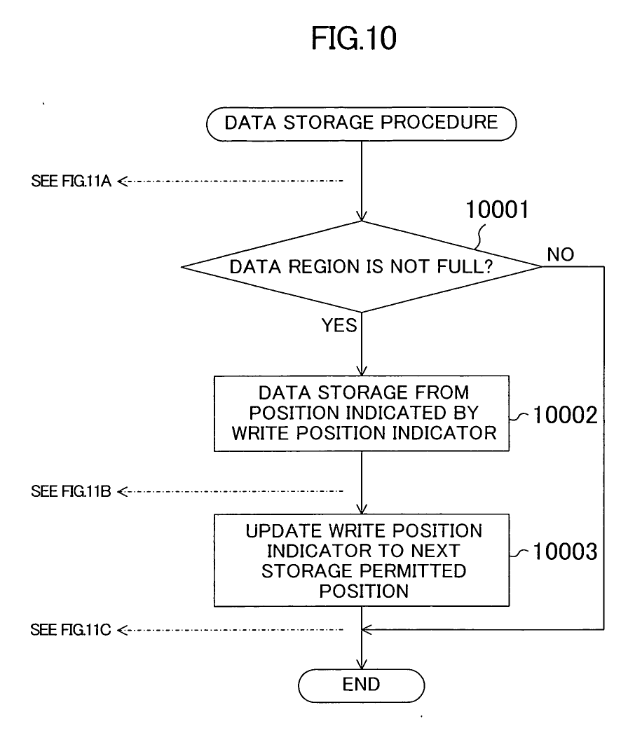

FIG. 10 illustrates a data storage procedure wherein the data storage region 210 of FIG. 9 is employed. According to FIG. 10, the write position indicator (W) and the read position indicator (R) are checked in the first place (step 10001). If it is determined that writing in the data region is permitted, storage of data is started from a position indicated by the write position indicator (W) (step 10002). Then, the write position indicator (W) is updated to the trailing end of the stored data, i.e., a next position in which data storage is permitted (step 10003).

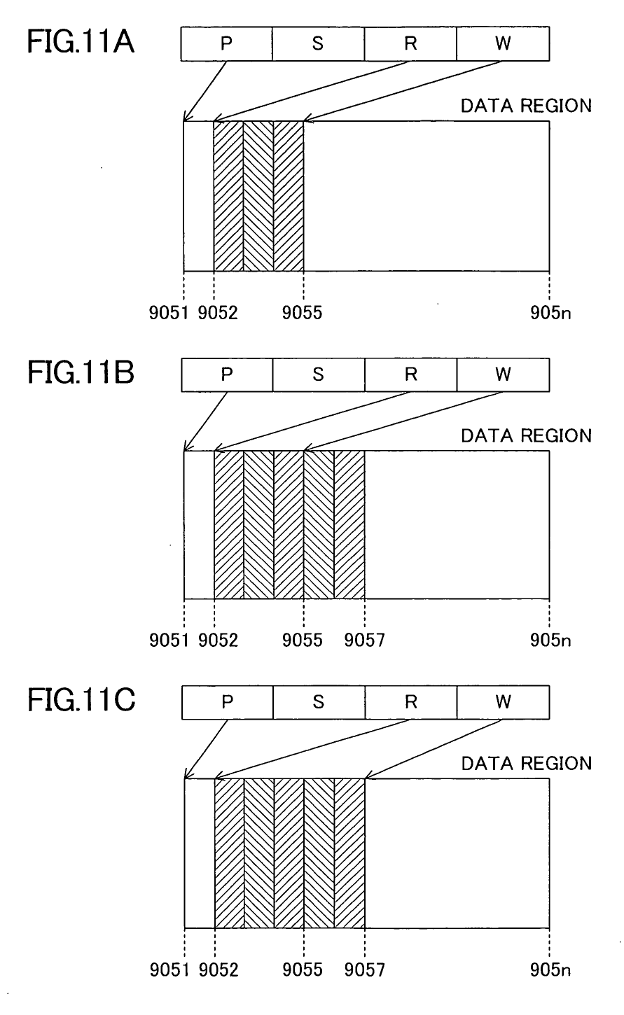

FIG. 11A shows the data storage region 210 wherein data is stored in the data regions 9052 to 9055. The read position indicator (R) indicates a position 9052, and the write position indicator (W) indicates a position 9055. FIG. 11B shows the state of the data storage region 210 at the time when steps 10001 and 10002 of FIG. 10 are completed. The data of the data storage regions 9055 to 9057 are newly-stored data. FIG. 11C shows the state of the data storage region 210 at the end of step 10003.

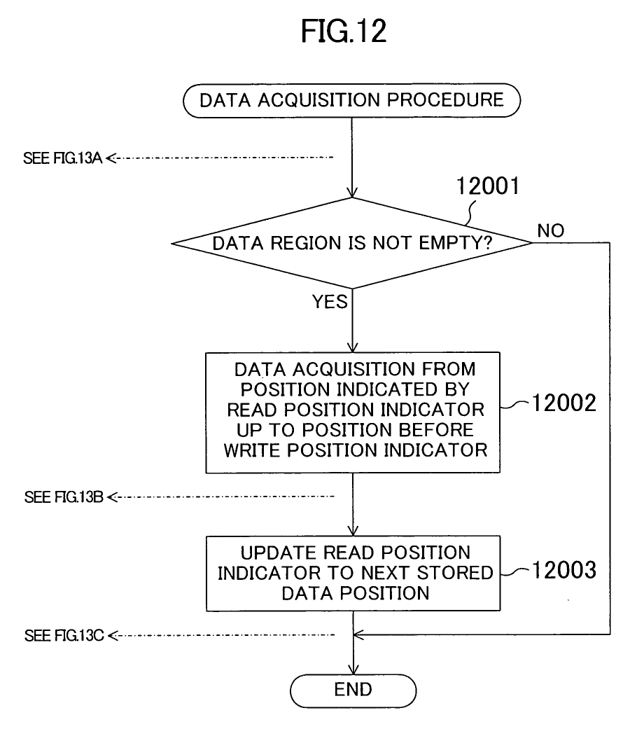

FIG. 12 illustrates a data acquisition procedure wherein the data storage region 210 of FIG. 9 is employed. According to FIG. 12, the write position indicator (W) and the read position indicator (R) are checked in the first place (step 12001). If it is determined that reading from the data region is permitted, data is acquired from an area that extends from a position indicated by the read position indicator (R) to any position before the write position indicator (W) (step 12002). Then, the read position indicator (R) is updated to the leading pointer of unread data (step 12003).

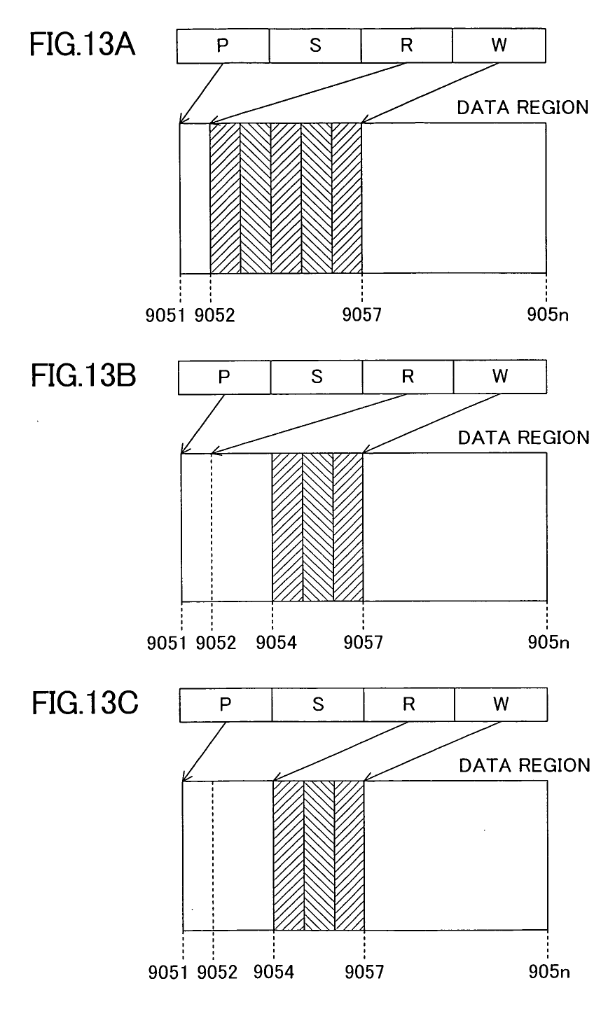

FIG. 13A shows the state of the data storage region 210 wherein data are stored in the data regions 9052 to 9057. The read position indicator (R) indicates a position 9052, and the write position indicator (W) indicates a position 9057. FIG. 13B shows the state of the data storage region 210 at the time when steps 12001 and 12002 of FIG. 12 are completed. The data of the data storage regions 9052 to 9054 are the read data. FIG. 13C shows the state of the data storage region 210 at the end of step 12003.

### Embodiment 2

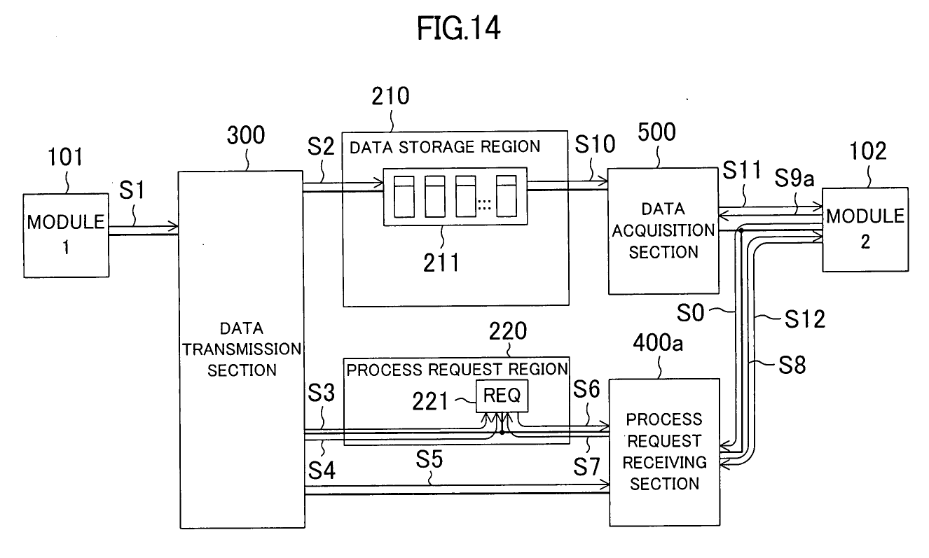

FIG. 14 shows the second embodiment of the data communication device of the present invention. The data communication device of FIG. 14 has a process request receiving section 400a. The process request receiving section 400a receives a data communication process request from the data transmission section 300 to repeatedly notify the reception module 102 about data storage in a data storage region 210 with a pre-registered data acquisition interval till the process request receiving section 400a receives a stop request for stopping a data storage notice from the reception module 102 (S12).

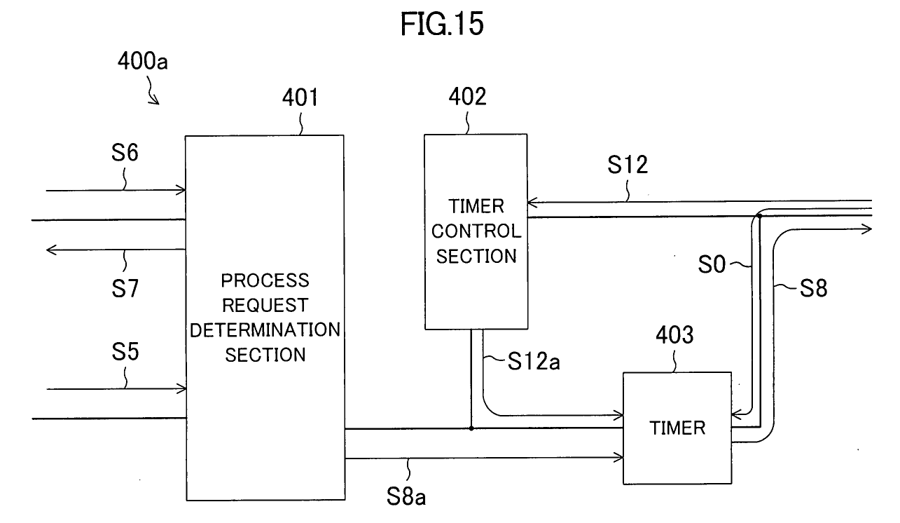

FIG. 15 shows an example of a detailed structure of the process request receiving section 400a of FIG. 14. As shown in FIG. 15, the process request receiving section 400a includes a timer 403, a process request determination section 401 and a timer control section 402. The timer 403 receives a request for registering a data acquisition interval from the reception module 102 to register this data acquisition interval as an interval of a data storage notice issued to the reception module 102. The timer 403 then notifies the reception module 102 about data storage in the data storage region 211 with the registered data storage notice interval. The process request determination section 401 receives a data communication process request from the data transmission section 300 to instruct the timer 403 to start operation. The timer control section 402 receives a stop request for stopping a data storage notice from the reception module 102 to instruct the timer 403 to stop operation.

Receiving a request for registering a data acquisition interval from the reception module 102 (S0), the timer 403 stores the data acquisition interval as an interval of a data storage notice issued to the reception module 102. Receiving from the module 101 transmission data and a data transmission request directed to the module 102 (S1), the data transmission section 300 stores the transmission data in the data storage region 211 (S2) and checks the process request region 220 (S3). If the process request region 220 does not include a process request 221 corresponding to the data storage region 211, the data transmission section 300 writes a process request 221 corresponding to the data storage region 211 in the process request region 220 (S4) and issues an interrupt to the process request receiving section 400a (S5). It should be noted that, if the process request region 220 already includes a process request 221 corresponding to the data storage region 211, the data transmission section 300 does not write the process request 221 in the process request region 220.

The process request determination section 401 receives the interrupt from the data transmission section 300 (S5) to determine the process request of the process request region 220 (S6). If the process request region 220 includes the process request 221, the process request determination section 401 clears the process request 221 (S7) and instructs the timer 403 to start an operation for the data storage region 211 (S8a). The timer 403 receives from the process request determination section 401 the instruction to start an operation for the data storage region 211 (S8a) and starts measurement and issues a data storage notice to the module 102 with the data storage notice interval for the module 102 (S8). If the reception module 102 receives a data reception notice from the timer 403 (S8), the reception module 102 issues a reception request of data to the data acquisition section 500 (S9a). If the module 102 receives a data storage notice from the module 101 (S8), the module 102 issues to the data acquisition section 500 a reception request of transmission data from the module 101 to the module 102 to acquire data (S10, S11). When receiving from the data acquisition section 500 a notice that the data storage region 211 includes no data which is permitted to be read, the module 102 issues a stop request for stopping a data storage notice to the timer control section 402 (S12). In the meantime, when receiving from the module 102 a request for reception of transmission data from the module 101 (S9a), the data acquisition section 500 acquires data from the data storage region 211 (S10) and transfers the acquired data to the module 102 (S11). It should be noted that, if the data storage region 211 includes no data which is permitted to be read, the data acquisition section 500 notifies the module 102 that the data storage region 211 includes no data which is permitted to be read (S11).

When the timer control section 402 receives the stop request for stopping a data storage notice from the module 102 (S12), the timer control section 402 instructs the timer 403 to stop the operation provided for the data storage region 211 (S12a). The timer 403 receives from the timer control section 402 the instruction to stop the operation provided for the data storage region 211 (S12a) to terminate the measurement of the interval of the data storage notice issued to the module 102 and terminate the data storage notice to the module 102.

In the data communication device of FIG. 14, a data storage notice is issued to the module 102 with a predetermined interval irrespective of the data transmission timing of the module 101. Thus, the data communication device of FIG. 14 is especially effective in a communication with the module 102 which periodically starts operation to perform data processing.

### Embodiment 3

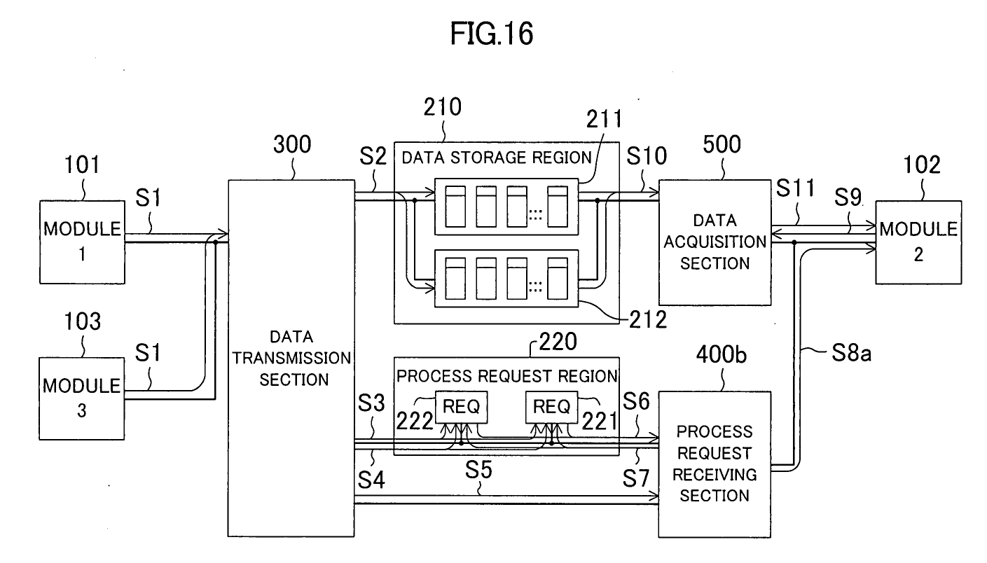

FIG. 16 shows the third embodiment of the data communication device of the present invention. The data communication device of FIG. 16 has a process request receiving section 400b. The process request receiving section 400b receives a data communication process request from the data transmission section 300. If there are process requests from a plurality of modules 101 and 103 for the same module 102, the process request receiving section 400b sends a notice of data storage in the reception module 102 once together with transmission origin module information.

The data storage region 210 secures an exclusive region for each of the combinations of the transmission modules 101 and 103 and the reception module 102. As for the structure, the data storage region 210 includes a region in which transmission data is to be written and an identifier which indicates whether or not the write region of the transmission data is permitted to be read.

The process request region 220 represents a data communication process request for the data storage region exclusively provided for each combination of the transmission modules 101 and 103 and the reception module 102 in the data storage region 210. For example, the process request region 220 may be a queue for storing a pointer of the data storage region which includes a data reception request on a request issuance time series basis.

When transmitting data, the modules 101 and 103 issue transmission requests including transmission destination module information and transmission data to the data transmission section 300 (S1). Receiving from the module 101 the transmission data and the data transmission request directed to the module 102 (S1), the data transmission section 300 stores the transmission data in the data storage region 211 which is provided for data transmission from the module 101 to the module 102 (S2) and checks the process request region 220 (S3). If the process request region 220 does not include a process request 221 which corresponds to the data storage region 211, the data transmission section 300 writes a process request 221 which corresponds to the data storage region 211 in the process request region 220 (S4) and issues an interrupt to the process request receiving section 400b (S5). If the process request region 220 already includes a process request 221 which corresponds to the data storage region 211, the data transmission section 300 does not write a process request 221 in the process request region 220.

Receiving from the module 103 the transmission data and the data transmission request directed to the module 102 (S1), the data transmission section 300 stores the transmission data in the data storage region 212 which is provided for data transmission from the module 103 to the module 102 (S2) and checks the process request region 220 (S3). If the process request region 220 does not include a process request 222 which corresponds to the data storage region 212, the data transmission section 300 writes a process request 222 which corresponds to the data storage region 212 in the process request region 220 (S4) and issues an interrupt to the process request receiving section 400b (S5). If the process request region 220 already includes a process request 222 which corresponds to the data storage region 212, the data transmission section 300 does not write a process request 222 in the process request region 220.

The process request receiving section 400b receives the interrupt from the data transmission section 300 (S5) to determine the process request of the process request region 220 (S6). If the process request region 220 includes a plurality of process requests for the same module 102, for example, if the process request region 220 includes a process request 221 from the module 101 to the module 102 and a process request 222 from the module 103 to the module 102, the process request receiving section 400b clears the process request 221 and the process request 222 (S7) and notifies the module 102 about the data reception from the module 101 and the data reception from the module 103 together at one time (S8a).

The module 102 receives the notice of data reception from the process request receiving section 400b (S8a) to repeatedly issue a data reception request to the data acquisition section 500 till the data acquisition section 500 issues a notice that the data storage region includes no data which is permitted to be read (S9).

If the reception module 102 receives the notice of data reception from the module 101 and the module 103 (S8a), the reception module 102 issues to the data acquisition section 500 a reception request of the transmission data from the module 101 to the module 102 and repeats a data acquisition process (S9). When receiving from the data acquisition section 500 a notice that the data storage region 211 includes no data which is permitted to be read, the module 102 terminates the repetitive process of step S9. In the meantime, the reception module 102 issues to the data acquisition section 500 a reception request of the transmission data from the module 103 to the module 102 and repeats a data acquisition process (S9). When receiving from the data acquisition section 500 a notice that the data storage region 212 includes no data which is permitted to be read, the module 102 terminates the process.

When receiving from the module 102 the request for reception of transmission data from the module 101 (S9), the data acquisition section 500 acquires data from the data storage region 211 (S10) and transfers the acquired data to the module 102 (S11). It should be noted that, if the data storage region 211 includes no data which is permitted to be read, the data acquisition section 500 notifies the module 102 that the data storage region 211 includes no data which is permitted to be read (S11). As well, when receiving from the module 102 the request for reception of transmission data from the module 103 (S9), the data acquisition section 500 acquires data from the data storage region 212 (S10) and transfers the acquired data to the module 102 (S11). It should be noted that, if the data storage region 212 includes no data which is permitted to be read, the data acquisition section 500 notifies the module 102 that the data storage region 212 includes no data which is permitted to be read (S11).

In the data communication device of FIG. 16, generation of a data storage notice signal is suppressed to only one time even when the plurality of modules 101 and 103 transmit data to the same module 102. Thus, the data communication device of FIG. 16 is effective in suppressing interruption of a process by an interrupt.

### Embodiment 4

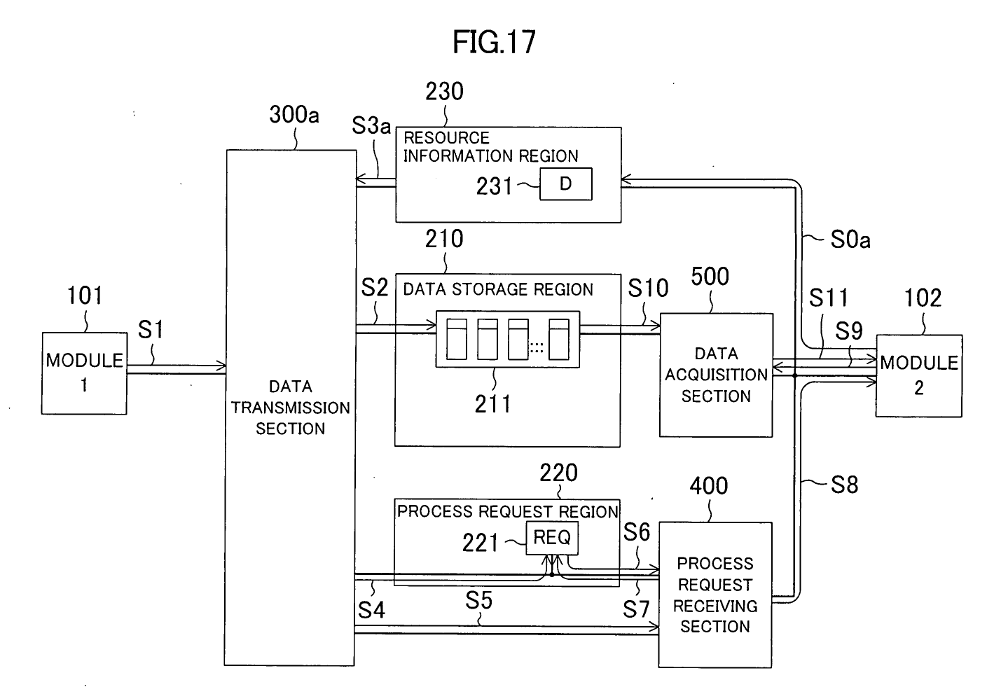

FIG. 17 shows the fourth embodiment of the data communication device of the present invention. The memory of the data communication device of FIG. 17 is also used for a resource information region 230 as well as the data storage region 210 and the process request region 220. The resource information region 230 stores the data amount (D) which corresponds to the timing of issuing a data storage notice to the module 102.

The data storage region 210 secures an exclusive region for each of the combinations of the transmission module 101 and the reception module 102. As for the structure, the data storage region 210 includes a region in which transmission data is to be written and an identifier which indicates whether or not the write region of the transmission data is permitted to be read. For example, the data storage region 210 has the structure shown in FIG. 9. In the data storage region 210 having the structure shown in FIG. 9, the amount of data which is permitted to be read can be defined by the difference between the write position indicator (W) and the read position indicator (R).

The resource information region 230 includes notice data amount information (D) for each module communication path. Receiving from the module 102 a data acquisition interval registration request to the resource information region 230 (S0a), the resource information region 230 stores the data acquisition interval as a data storage notice interval to the module 102. For example, when receiving from the module 102 a data acquisition interval registration request to the resource information region 230 (S0a), the resource information region 230 stores a notice data amount 231 with the data acquisition interval as the data storage notice interval to the module 102.

When transmitting data, the module 101 issues a transmission request including transmission destination module information and transmission data to a data transmission section 300a (S1). Receiving from the module 101 the transmission data and the data transmission request directed to the reception module 102 (S1), the data transmission section 300a stores the transmission data in the data storage region 211 (S2) and determines the notice data amount 231 in the resource information region 230 to the module 102 (S3a). The determined notice data amount 231 is then compared with the data amount of the data storage region 211. If the data amount of the data storage region 211 is equal to or larger than the notice data amount 231, the data transmission section 300a writes a process request 221 which corresponds to the data storage region 211 in the process request region 220 (S4) and issues an interrupt to the process request receiving section 400 (S5). If the data amount of the data storage region 211 is smaller than the notice data amount 231, the data transmission section 300a does not write a process request 221 in the process request region 220.

The process request receiving section 400 receives the interrupt from the data transmission section 300a (S5) to determine the process request of the process request region 220 (S6). If the process request region 220 includes the process request 221, the process request receiving section 400 clears the process request 221 (S7) and notifies the module 102 about the data reception from the module 101 (S8). If the reception module 102 receives the notice of data reception from the process request receiving section 400 (S8), the reception module 102 repeatedly issues a data reception request to the data acquisition section 500 till the data acquisition section 500 issues a notice that the data storage region includes no data which is permitted to be read (S9). When receiving from the data acquisition section 500 a notice that the data storage region 211 includes no data which is permitted to be read, the module 102 terminates the process. When receiving from the module 102 the request for reception of transmission data from the module 101 (S9), the data acquisition section 500 acquires data from the data storage region 211 (S10) and transfers the acquired data to the module 102 (S11). It should be noted that, if the data storage region 211 includes no data which is permitted to be read, the data acquisition section 500 notifies the module 102 that the data storage region 211 includes no data which is permitted to be read (S11).

In the data communication device of FIG. 17, the module 102 sleeps till the module 102 receives a notice of data reception, and after reception of the notice of data reception, the module 102 acquires and processes data without interruption. Thus, when the module 102 operates at a sufficiently high speed with respect to the module 101, the data communication device of FIG. 17 is effective in suppressing power consumption.

### Embodiment 5

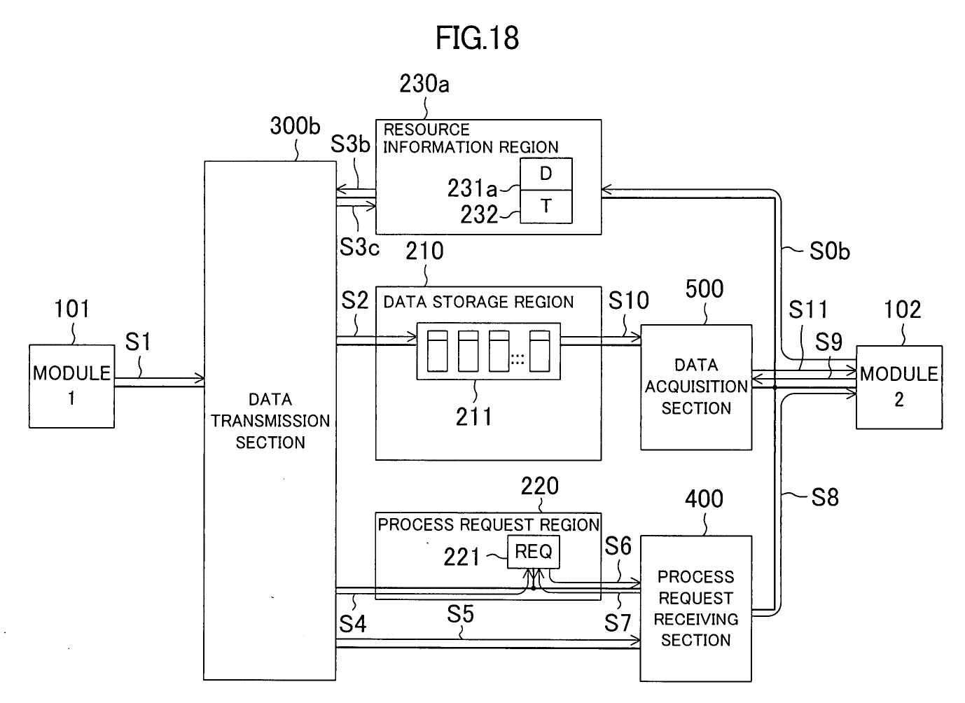

FIG. 18 shows the fifth embodiment of the data communication device of the present invention. The memory of the data communication device of FIG. 18 is also used for a resource information region 230a as well as the data storage region 210 and the process request region 220. The resource information region 230a stores the data amount (D) which corresponds to the timing of issuing a data storage notice to the module 102 and the total amount of transmission data (T).

The data storage region 210 secures an exclusive region for each of the combinations of the transmission module 101 and the reception module 102. As for the structure, the data storage region 210 includes a region in which transmission data is to be written and an identifier which indicates whether or not the write region of the transmission data is permitted to be read. For example, the data storage region 210 has the structure shown in FIG. 9.

When receiving from the module 102 a request for registering the amount of data for which a data storage notice is to be issued (S0b), the resource information region 230a stores the amount of data for which a data storage notice is to be issued as a data storage notice data amount 231a to the module 102. Further, the amount of stored data is added to a transmission data total amount 232 at every data storage for each of the exclusive regions between the transmission module 101 and the reception module 102 in the data storage region 210. Then, the resource information region 230a receives from a data transmission section 300b a request for clearing the transmission data total amount to initialize the transmission data total amount 232.

When transmitting data, the module 101 issues a transmission request including transmission destination module information and transmission data to the data transmission section 300b (S1). Receiving from the module 101 the transmission data and the data transmission request directed to the reception module 102 (S1), the data transmission section 300b stores the transmission data in the data storage region 211 (S2) and adds the size of the transmission data to the transmission data total amount 232 for the data storage region 211 of the resource information region 230a (S3b). Then, the transmission data total amount 232 is compared with the data storage notice data amount 231a for the module 102 which is stored in the resource information region 230a. If the transmission data total amount 232 is equal to or larger than the data storage notice data amount 231a, the data transmission section 300b initializes the transmission data total amount 232 (S3c), writes a process request 221 which corresponds to the data storage region 211 in the process request region 220 (S4), and issues an interrupt to the process request receiving section 400 (S5). If the transmission data total amount 232 is smaller than the notice data amount information 231a, the data transmission section 300b does not write a process request 221 in the process request region 220.

The process request receiving section 400 receives the interrupt from the data transmission section 300b (S5) to determine the process request of the process request region 220 (S6). If the process request region 220 includes the process request 221, the process request receiving section 400 clears the process request 221 (S7) and notifies the module 102 about the data reception from the module 101 (S8). If the reception module 102 receives the notice of data reception from the module 101 (S8), the process request receiving section 400 issues to the data acquisition section 500 a reception request of transmission data from the module 101 to the module 102 and repeats a data acquisition process (S9). When receiving from the data acquisition section 500 a notice that the data storage region 211 includes no data which is permitted to be read, the process request receiving section 400 terminates the process. When receiving from the module 102 the request for reception of transmission data from the module 101 (S9), the data acquisition section 500 acquires data from the data storage region 211 (S10) and transfers the acquired data to the module 102 (S11). It should be noted that, if the data storage region 211 includes no data which is permitted to be read, the data acquisition section 500 notifies the module 102 that the data storage region 211 includes no data which is permitted to be read (S11).

In the data communication device of FIG. 18, the module 102 receives a data reception notice when the data amount set as the notice data amount 231a is stored in the data storage region 211. Thus, the data communication device of FIG. 18 is especially effective in, for example, a communication of multimedia stream data which needs to be processed on an image-frame by image-frame basis.

As described above, according to a data communication device of the present invention, when data is continuously transmitted between modules which operate independently of each other, the number of interrupts is reduced, and interruption of a process is suppressed. Thus, the data communication device of the present invention is useful for intermodule multimedia stream data communication and therefore applicable to applications of mobile phones, AV devices, etc.

What is claimed is:

1. A data communication device used for communication between software modules of processors, comprising:
a memory including a data storage region and a process request region, the data storage region having an identifier indicative of a first state or a second state, the process request region indicating whether or not there is a process request for data transmission;
a data transmission section which receives from at least one transmission module a request for data transmission to store data in a region in which the identifier of the data storage region indicates the second state and then change the identifier to the first state and, only when a process request is not yet written in the process request region, writes a process request in the process request region to generate a notice signal;
a process request receiving section which receives the notice signal to confirm that a process request is written in the process request region and then clears the process request to notify a reception module about data storage in the data storage region; and
a data acquisition section which receives from the reception module a request for data reception to acquire data from a region in which the identifier of the data storage region indicates the first state and then change the identifier to the second state.

2. The data communication device of claim 1, wherein:
the first state of the identifier is data read permission; and
the second state of the identifier is data read prohibition.

3. The data communication device of claim 1, wherein:
the first state of the identifier is data write prohibition; and
the second state of the identifier is data write permission.

4. The data communication device of claim 1, wherein the process request receiving section includes:
a timer which receives from the reception module a registration request for a data acquisition interval to register the data acquisition interval as an interval of a data storage notice to the reception module and notifies the reception module about data storage in the data storage region according to the interval of the data storage notice;
a process request determination section which receives the notice signal to confirm that a process request is written in the process request region and then clears the process request to instruct the timer to start operation; and
a timer control section which receives from the reception module a stop request for a data storage notice to instruct the timer to stop operation.

5. The data communication device of claim 1, wherein when process requests from a plurality of transmission modules to a same reception module are written in the process request region, the process request receiving section clears all the plurality of process requests and notifies the reception module only once about data storage in the data storage region together with transmission module information.

6. A data communication device used for communication between software modules of processors, comprising:
a memory including a data storage region, a process request region, and a resource information region in which a notice data amount is registered, the data storage region having an identifier indicative of a first state or a second state, the process request region indicating whether or not there is a process request for data transmission;
a data transmission section which receives from at least one transmission module a request for data transmission to store data in a region in which the identifier of the data storage region indicates the second state and then change the identifier to the first state and, only when a stored data amount of the data storage region is equal to or larger than the notice data amount registered in the resource information region, writes a process request in the process request region to generate a notice signal;
a process request receiving section which receives the notice signal to confirm that a process request is written in the process request region and then clears the process request to notify a reception module about data storage in the data storage region; and
a data acquisition section which receives from the reception module a request for data reception to acquire data from a region in which the identifier of the data storage region indicates the first state and then change the identifier to the second state.

7. The data communication device of claim 6, wherein:
the resource information region further includes information which represents the total amount of data already stored in the data storage region; and
the data transmission section receives from at least one transmission module a request for data transmission to store data in a region in which the identifier of the data storage region indicates the second state and then change the identifier to the first state and, only when the total amount of data already stored in the data storage region is equal to or larger than the notice data amount registered in the resource information region, initializes the information which represents the total amount of the already-stored data and writes a process request in the process request region to generate a notice signal.

8. A data communication method used for communication between software modules of processors, comprising the steps of:
securing a data storage region and a process request region on a memory, the data storage region having an identifier indicative of a first state or a second state, the process request region indicating whether or not there is a process request for data transmission;
receiving from at least one transmission module a request for data transmission to store data in a region in which the identifier of the data storage region indicates the second state and then changing the identifier to the first state and, only when a process request is not yet written in the process request region, writing a process request in the process request region to generate a notice signal;
receiving the notice signal to confirm that a process request is written in the process request region and then clearing the process request to notify a reception module about data storage in the data storage region; and
receiving from the reception module a request for data reception to acquire data from a region in which the identifier of the data storage region indicates the first state and then changing the identifier to the second state.

9. A data communication system used for communication between software modules of processors, comprising:
a processor for executing a transmission module and a reception module;
a memory including a data storage region and a process request region, the data storage region having an identifier indicative of a first state or a second state, the process request region indicating whether or not there is a process request for data transmission;
a data transmission section which receives from the transmission module a request for data transmission to store data in a region in which the identifier of the data storage region indicates the second state and then change the identifier to the first state and, only when a process request is not yet written in the process request region, writes a process request in the process request region to generate a notice signal;
a process request receiving section which receives the notice signal to confirm that a process request is written in the process request region and then clears the process request to notify the reception module about data storage in the data storage region; and
a data acquisition section which receives from the reception module a request for data reception to acquire data from a region in which the identifier of the data storage region indicates the first state and then change the identifier to the second state.

10. A data communication program used for communication between software modules of processors, the data communication program instructing a computer to execute the steps of:
securing a data storage region and a process request region on a memory, the data storage region having an identifier indicative of a first state or a second state, the process request region indicating whether or not there is a process request for data transmission;
receiving from at least one transmission module a request for data transmission to store data in a region in which the identifier of the data storage region indicates the second state and then changing the identifier to the first state and, only when a process request is not yet written in the process request region, writing a process request in the process request region to generate a notice signal;
receiving the notice signal to confirm that a process request is written in the process request region and then clearing the process request to notify a reception module about data storage in the data storage region; and
receiving from the reception module a request for data reception to acquire data from a region in which the identifier of the data storage region indicates the first state and then changing the identifier to the second state.
